(19) United States
(12) Patent Application Publication
(10) Pub. No.: US 2021/0229322 A1
(43) Pub. Date: Jul. 29, 2021

(54) CONTAINERIZED CONCRETE BATCH PLANT

(71) Applicant: Neal Johnson, Miami Beach, FL (US)

(72) Inventor: Neal Johnson, Miami Beach, FL (US)

(21) Appl. No.: 16/752,203

(22) Filed: Jan. 24, 2020

(51) Int. Cl. B28C 9/04

(52) U.S. Cl. CPC B28C 9/0409; B28C 9/0454

(57) ABSTRACT

A containerized concrete batch plant is disclosed, comprising a container configured to contain a concrete batch plant to permit the transportation of the concrete batch plant. The concrete batch plant comprising a storage silo to receive a plurality of concrete elements from a modular conveyor. An aggregate storage silo receives the plurality of concrete elements for transfer to a scale and the mixing drum. A screw worm drive transfers the plurality of concrete elements from the mixing drum to the concrete pump.

### TECHNICAL FIELD

The embodiments relate to transportable concrete batch plants and, more specifically, relate to containerized concrete batch plants.

### BACKGROUND

Concrete is a composite material composed of fine and coarse aggregate bonded together with a fluid cement that hardens over time. Many types of concrete exist, including cementitious and non-cementitious types, each having different of binding aggregate together. Due to its vast building applications, concrete is one of the most frequently used building materials. In fact, its usage worldwide is, ton for ton, twice that of steel, wood, plastics, and aluminum combined.

A concrete plant, also known as a batch plant, includes equipment that combines various ingredients to form the concrete. Inputs include water, air, admixtures, sand, aggregate (e.g., rocks, gravel, etc.) fly ash, silica fume, slag, Portland cement, or cement paste. The batch plant will also include various components to perform various tasks, including mixers, cement batchers, aggregate batchers, conveyors, radial stackers, aggregate bins, cement bins, heaters, chillers, silos, batch plant controls, scales, and dust collectors.

Portable batch plants are a productive, reliable, and cost-effective means to producing batches of concrete which allow the user to batch concrete in various locations. These systems are often used for temporary site projects. However, portable batch plants are also useful in locations where the equipment size is a factor, or the required production rate is low. Similarly, these systems are employed in locations where the concrete requirements of the job site is not feasibly covered by the inbound transport of concrete mixed at an offsite location.

For this reason, many construction companies utilize a transportable mixing plant that is erected at a jobsite to produce concrete on-site. The transportable mixing plant must then be deconstructed and arranged for transport to the next jobsite at which it is required. This process results in the use of large amounts of resources (in materials, consumables, time, and personnel) to assemble and transport the mixing plant.

### SUMMARY OF THE INVENTION

This summary is provided to introduce a variety of concepts in a simplified form that is further disclosed in the detailed description. This summary is not intended to identify key or essential inventive concepts of the claimed subject matter, nor is it intended for determining the scope of the claimed subject matter.

The present embodiments disclose a containerized concrete batch plant comprising a container configured to contain a concrete batch plant to permit the transportation of the concrete batch plant. The concrete batch plant comprising a storage silo to receive a plurality of concrete elements from a modular conveyor. An aggregate storage silo receives the plurality of concrete elements for transfer to a scale and the mixing drum. A screw worm drive transfers the plurality of concrete elements from the mixing drum to the concrete pump.

The containerized concrete batch plant allows for construction companies, concrete companies, or like enterprises to easily transport a concrete batch plant between jobsites without undue assembly and disassembly, thus saving resources. The containerized concrete batch plant is self-contained within a single container which conforms to ISO standards, at least while in a transport configuration, and includes a modified container which allows for shipping and full operation of the concrete batch plant.

In one aspect, the containerized concrete batch plant further comprises a sealed belly tank having a plurality of partitions to facilitate the storage of various resources comprising water, fuel, and a plurality of concrete elements and admixtures.

In one aspect, the mixer is in communication with a hydraulic support to raise and lower the mixer.

In one aspect, the screw worm drive is disposed within a housing having a removeable side plate to facilitate cleaning of the screw worm drive.

In one aspect, the containerized concrete batch plant further comprises a telescoping conveyor.

In one aspect, the container is further comprised of a door having an actuator to open and close the door.

In one aspect, the modular conveyor is engaged to a top portion of the door.

In one aspect, the container is constructed having ISO standards.

### BRIEF DESCRIPTION OF THE DRAWINGS

A more complete understanding of the present invention and the advantages and features thereof will be more readily understood by reference to the following detailed description when considered in conjunction with the accompanying drawings wherein:

FIG. 1 illustrates a perspective view of the containerized concrete batch plant in a transport configuration, according to some embodiments;

FIG. 2 illustrates a side elevation view of the containerized concrete batch plant in a transport configuration, according to some embodiments;

FIG. 3 illustrates a side elevation view of the containerized concrete batch plant in an operational configuration, according to some embodiments;

FIG. 4 illustrates a perspective view of the containerized concrete batch plant in an operational configuration, according to some embodiments;

FIG. 5 illustrates a top plan view of the containerized concrete batch plant in an operational configuration, according to some embodiments; and

FIG. 6 illustrates a side elevation view of the containerized concrete batch plant, according to some embodiments.

### DETAILED DESCRIPTION

The specific details of the single embodiment or variety of embodiments described herein are to a system and method of use. Any specific details of the embodiments are used for demonstrative purposes only and no unnecessary limitations or inferences are to be understood therefrom.

Before describing in detail exemplary embodiments, it is noted that the embodiments reside primarily in combinations of components related to the system and method. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second”, “top” and bottom”, and the like, may be used solely to distinguish one entity or element from another entity or element without necessarily requiring or implying any physical or logical relationship or order between such entities or elements.

As used herein, the term “concrete element” may include any concrete material including fine and course aggregates, fluid cements (of any type including lime-based cement binder, lime putty, hydraulic cements such as aluminate cement, or portland cement). Concrete elements may also include non-cementitious types of concrete with various forms of binding aggregates.

As used herein, the term “resources” may include various resources utilized by a concrete batch plant and the embodiments herein including water, fuel sources, and other consumables which may or may not be directly used in concrete.

In general, the embodiments described herein relate to a containerized concrete batch plant which is sufficient to form concrete in various locations while being contained within a portable container having standard International Organization for Standardization (ISO) dimensions. The container is suitable for transportation by ship, rail, and truck to a location for deployment. The containerized batch plant is configured to be reusable in various locations without undue assembly and deconstruction between each location. The containerized concrete batch plant comprises a plurality of stabilization outriggers, aggregate intake hopper, a conveyor system to an aggregate dispenser, motorized bin selector for dispenser, concrete elements storage silos, computer controlled actuators for dispensing concrete elements from the storage silos onto a scale, conveying system to an inbound hopper of the mixing drum, concrete pumps, steel concrete pump tubing, concrete hoses, a concrete pump nozzle, an onboard generator, fuel tank, and an onboard computer control system, in addition to standard components included in a concrete batch plant known to those skilled in the arts.

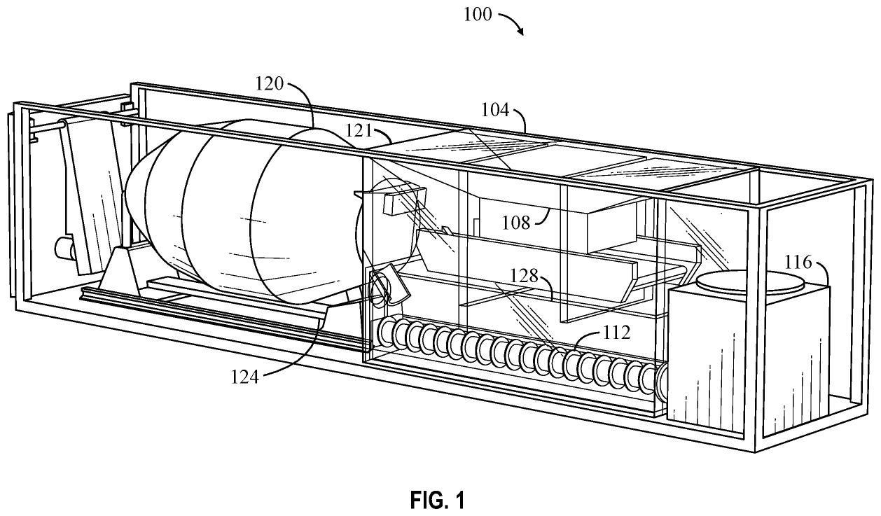

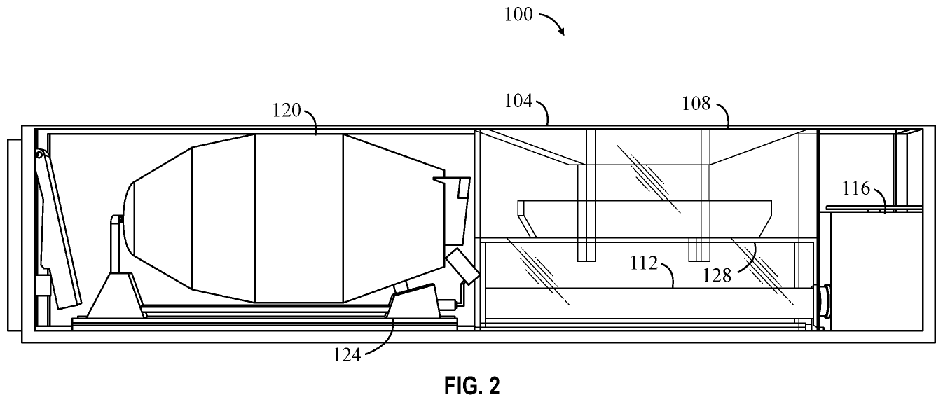

In reference to FIG. 1 and FIG. 2, the containerized concrete batch plant 100 is illustrated in an exemplary embodiment. FIGS. 1-2 show the containerized concrete batch plant 100 in a storage configuration wherein the components are contained within a single container 104 to comply with ISO shipping standards. The containerized concrete batch plant 100 is provided in the container 104 which is configured to meet ISO standards and is capable of being shipped anywhere in the world by truck, rail, and by a shipping vessel to various jobsites. The container 104 houses the various components of the containerized concrete batch plant 100 which is utilized to form concrete. A storage silo 108 is provided to store various elements which are used to form the concrete such as cement, sand, and aggregates. The concrete elements are transferred from the storage silo 108 to the mixer 120. The container 104 also houses a concrete pump 116. A mixer 120 is raised and lowered via a hydraulic support 124 during mixing of the concrete by the containerized concrete batch plant 100. The hydraulic support 124 may be returned to a lowered position (see FIG. 1) during the transport of the containerized concrete batch plant 100. A sealed belly tank 128 is utilized for water storage, fuel storage, and storage of other cement elements (such as Portland cement, fly ash, or other additives).

In some embodiments, the partitioned aggregate storage silo includes a self-erecting sleeved component 121 (shown in FIG. 1) to partition the aggregate storage silos and allow for a portion of the container to be raised during operation, servicing, or likewise functions of the containerized concrete batch plant. The self-erecting sleeve component 121 is raised and lowered hydraulically and contains a plurality of steel plates at one end, which then slide on a track and then lock into position to form the dividing walls within the aggregate storage silos once in the raised position. A locking mechanism may allow the self-erecting sleeve component to be locked into a raised or lowered position during use.

In some embodiments, the storage silo may be comprised of a plurality of compartments to store the various elements utilized during the concrete formation process. One skilled in the arts will readily understand that various configurations of storage silos may be employed depending on the application of the containerized concrete batch plant at a particular jobsite.

In some embodiments, the concrete pump is configured to receive materials from the intake hopper wherein materials are dispensed.

In some embodiments, the screw worm drive includes a housing having a removeable side plate to facilitate cleaning.

In some embodiments, the concrete pump feeds a concrete conduit having a diameter between 2-5 inches depending on the pump capacity. This allows for the direct dispatching of concrete on a jobsite from the containerized concrete batch plant. In an alternate embodiment, the concrete may be hard-piped into another vertical concrete pump, which is particularly useful wherein the jobsite is a high-rise structure or a similarly tall structure having multiple levels in which concrete is poured. This allows for the direct dispensing of concrete rather than first dispensing the concrete into another vehicle or delivery system.

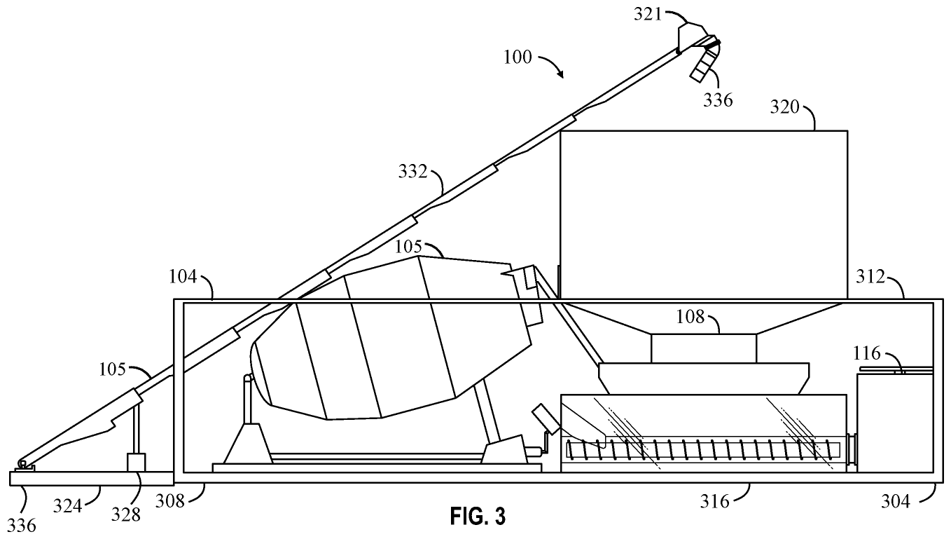

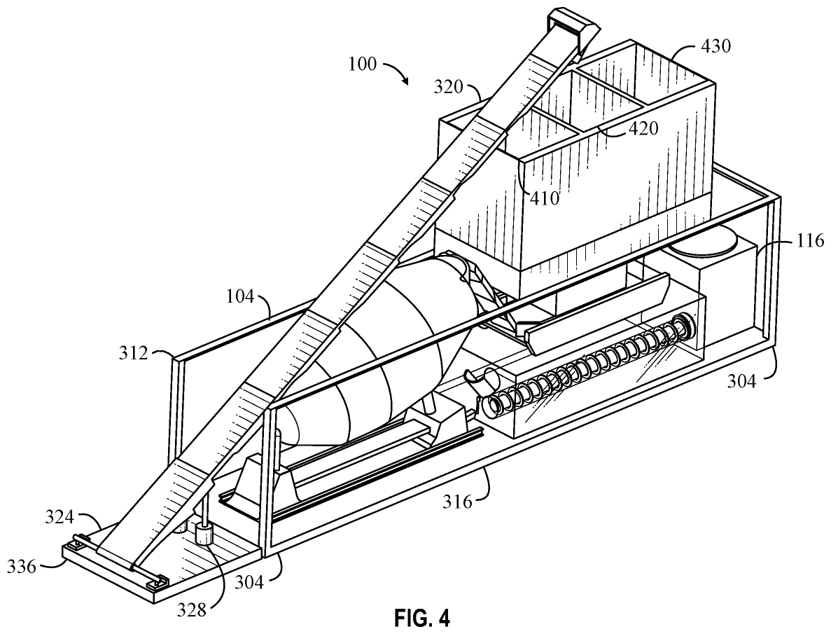

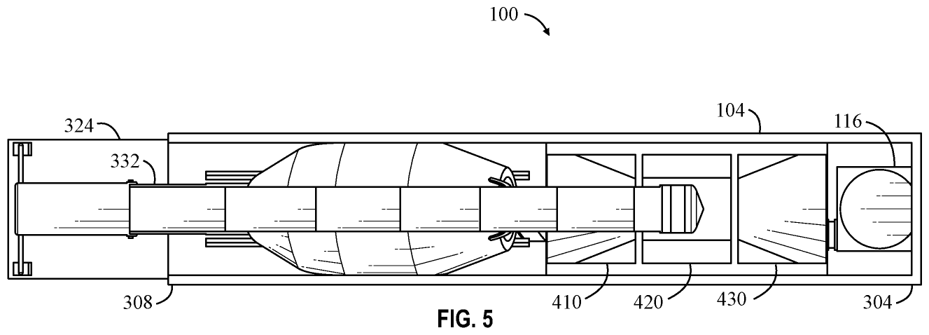

FIG. 3, FIG. 4, and FIG. 5 illustrate the containerized concrete batch plant 100 in an in-use configuration to illustrate an embodiment wherein concrete is being formed in at least one aspect of the process. The scale weights the concrete elements and inputs the weighed concrete elements on a conveyor system leading to the mixing drum intake hopper. The container 104 is comprised of a first end 304, a second end 308, a top 312, and a bottom 316. The concrete pump 116 is positioned to be in operable communication with an aggregate intake hopper 105 and storage silo 320 positioned near the first end 304 of the container 104. The second end 308 of the container 104 comprises a selectively positioned door 324 in communication with an actuator 328 to open and close (such as by raising and lowering) the door. A modular conveyor 332 extends from the top portion 336 of the door 324 and conveys concrete elements into the aggregate storage silos 320. The modular conveyor 332 terminates in a telescopic conveyor 336 and aggregate dispenser 321 which permits the concrete elements to pass therethrough and dispense into the aggregate storage silos 320. The motorized dispenser is controlled by a selector switch which controls the direction of aggregate flow into the storage silos 320.

The concrete elements are transferred from the aggregate storage silos to the mixing drum via a conveyor. The worm drive feeds the mixed concrete elements from the mixing drum to the concrete pump which dispenses the concrete via a hose.

In specific reference to FIGS. 4 and 5, the aggregate storage silos 320 is comprised of a plurality of partitions 410, 420, 430, which allow for the separation of concrete elements prior their disposal within the containerized concrete batch plant 100. The modular conveyor 332 is comprised of a plurality of conveyor beds to transfer the concrete elements into the aggregate storage silos 320. The modular conveyor 332 and the telescopic conveyor 336 (see FIG. 3) may each be self-articulating to allow for the on-board computer system to control the movement, operating speed, and position of each component of the conveyor system.

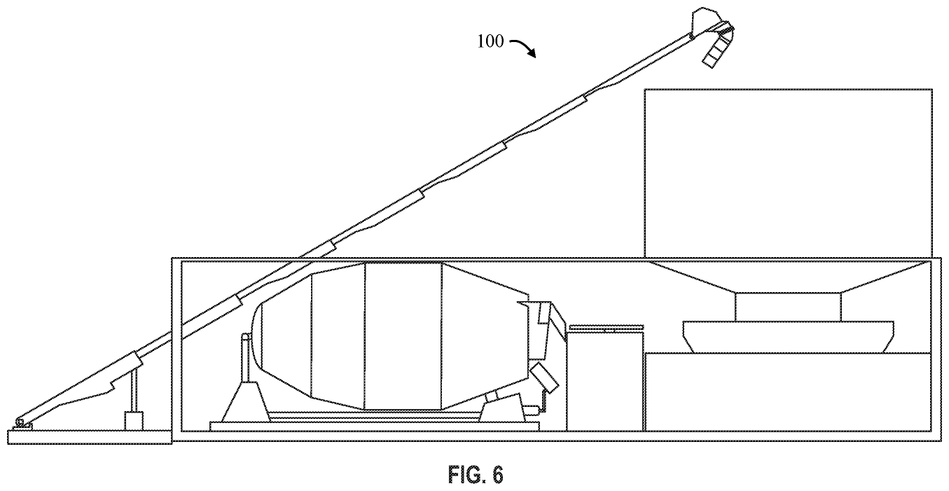

The container may be structurally modified to facilitate the batching of concrete via the containerized concrete batch plant. For example, as shown in FIG. 5, the top 312 of the container 104 may be removeable to allow for access to the various components of the containerized concrete batch plant 100. For example, at least a portion of the top 104 of the container 104 is removed before the concrete elements are dispensed into the aggregate storage silos 320. FIG. 6 illustrates an embodiment in which the screw drive is not used and wherein the location of the concrete pump within the silos has been changed with reference to FIG. 5.

Each stabilization outrigger may be utilized (whether individually or in combination with one another) to hydraulically lift the containerized concrete batch plant from a delivery truck, to level the containerized concrete batch plant prior to and during use, and to stabilize the working load and moment created when the concrete pump hoses are filled with concrete.

In some embodiments, the conveyor systems are controlled via the onboard computer system by changing the conveyor speed, conveyor direction, and conveyor position depending on the particular concrete element being conveyed.

In some embodiments, the intake hopper feeds the modular conveyor which has a directional spout and selector to feed the storage silos. The storage silos dispense via a computer controller by weight onto a secondary conveyor scale below the silos. The conveyor under the silos feeds concrete inputs into the mixing drum to mix the ingredients and form wet concrete. The mixing drum then outputs the mixed concrete into the screw drive which feeds the concrete pump which pumps concrete into the hose.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A containerized concrete batch plant, comprising:
a container configured to contain a concrete batch plant to permit the transportation of the concrete batch plant, the concrete batch plant comprising a storage silo to receive a plurality of concrete elements from a modular conveyor; an aggregate storage silo to receive the plurality of concrete elements for transfer to a scale and the mixing drum, a screw worm drive to transfer the plurality of concrete elements from the mixing drum to the concrete pump.

2. The containerized concrete batch plant of claim 1, further comprising a sealed belly tank having a plurality of partitions to facilitate the storage of various resources comprising water, fuel, and a plurality of concrete elements.

3. The containerized concrete batch plant of claim 1, wherein the mixer is in communication with a hydraulic support to raise and lower the mixer.

4. The containerized concrete batch plant of claim 1, wherein the screw worm drive is disposed within a housing having a removeable side plate to facilitate cleaning of the screw worm drive.

5. The containerized concrete batch plant of claim 1, further comprising a telescoping conveyor.

6. The containerized concrete batch plant of claim 1, wherein the container is further comprised of a fold down door having an actuator to open and close the door, and wherein the container is further comprised of an aggregate intake hopper.

7. The containerized concrete batch plant of claim 6, wherein the modular conveyor is engaged to a top portion of the door.

8. The containerized concrete batch plant of claim 1, wherein the container is constructed having ISO standards.

9. A containerized concrete batch plant, comprising:
a container configured to contain a concrete batch plant to permit the transportation of the concrete batch plant, the concrete batch plant comprising an aggregate intake hopper to receive the plurality of concrete elements and transfer the plurality of concrete elements to the aggregate storage silos; partitioned storage silo to receive a plurality of concrete elements from a modular conveyor via an aggregate dispenser; a scale to weight the plurality of concrete elements, a mixing drum to receive the weighed plurality of concrete components; a concrete pump fed via a screw worm drive, an onboard computer system to control the modular conveyor, the mixing drum and the concrete pump.

10. The system of claim 9, wherein the partitioned storage silo includes a self-erecting sleeved component to partition the plurality of concrete elements and to permit the adjustment of the size of the partitioned storage silo.

11. The containerized concrete batch plant of claim 9, further comprising a sealed belly tank having a plurality of partitions to facilitate the storage of various resources comprising water, fuel, and a plurality of concrete elements.

12. The containerized concrete batch plant of claim 9, wherein the mixer is in communication with a hydraulic support to raise and lower the mixer.

13. The containerized concrete batch plant of claim 9, wherein the screw worm drive is disposed within a housing having a removeable side plate to facilitate cleaning of the screw worm drive.

14. The containerized concrete batch plant of claim 9, further comprising a telescoping conveyor.

15. The containerized concrete batch plant of claim 9, wherein the container is further comprised of a door having an actuator to open and close the door.

16. The containerized concrete batch plant of claim 15, wherein the modular conveyor is engaged to a top portion of the door and the aggregate intake hopper.

17. The containerized concrete batch plant of claim 9, wherein the container is constructed having ISO standards.

18. The containerized concrete batch plant of claim 17, wherein the container is transportable via rail, vehicle, or shipping vessel.

19. The containerized concrete batch plant of claim 18, wherein the container includes a transport configuration and an operational configuration.

20. A containerized concrete batch plant, comprising:
a container configured to contain a concrete batch plant to permit the transportation of the concrete batch plant, the concrete batch plant comprising a partitioned storage silo to receive a plurality of concrete elements and resources from a stepped modular conveyor; an intake hopper to provide the plurality of concrete elements to the modular conveyor; the partitioned aggregate storage silo including a self-erecting sleeved component to partition the plurality of concrete elements and to permit the adjustment of the size of the partitioned storage silo; a concrete pump to expel the concrete, the concrete pump fed via a screw worm drive to transfer the plurality of concrete elements from the mixing drum to the concrete pump, an onboard computer system to control the modular conveyor, the mixer, and the concrete pump.
